(19) United States
(12) Patent Application Publication
(10) Pub. No.: US 2024/0235462 A1
(43) Pub. Date: Jul. 11, 2024

(54) SOLAR ENERGY SYSTEM AND METHOD FOR CONTROLLING SHADE IN AN ORCHARD

(71) Applicants: Yossi FISHER, Jerusalem (IL); AGRILIGHT ENERGY SYSTEMS LTD., Jerusalem (IL)

(72) Inventors: Yossi FISHER, Jerusalem (IL); Andreas FISLER, Kfar Maas (IL)

(21) Appl. No.: 18/289,119

(22) PCT Filed: Apr. 12, 2022
(86) PCT No.: PCT/IL2022/050378

§ 371 Date: Nov. 1, 2023

Related U.S. Application Data
(60) Provisional application No. 63/185,397, filed on May 7, 2021.

(51) Int. Cl. H02S 20/32; A01G 13/02

(52) U.S. Cl. CPC H02S 20/32; A01G 13/0206

(57) ABSTRACT

The present invention provides methods and systems for improved solar energy capture in an orchard, the system including at least one solar energy apparatus comprising at least one photovoltaic cell and at least one row of solar panels, deployed in the orchard to capture the solar energy from the sun and a processor configured to activate an algorithm for dynamic control of at least one of a position of incidence of shading from said at least one row of solar panels and an area of incidence of shading from said at least one row of solar panels on ground parallel to said rows of trees.

### FIELD OF THE INVENTION

The present invention relates generally to systems and methods for improving yields from sunlight, and more specifically to methods and apparatus for combining agricultural technologies with solar energy-driven apparatus.

### BACKGROUND OF THE INVENTION

Most land-based photosynthetic plants absorb carbon dioxide from the air and energy from sunlight. Solar energy-driven systems can be deployed in outdoor agricultural environments. The direct effect of shading from these solar systems on agricultural crops in their vicinity, influences the intensities of solar radiation reaching the plants photosynthetic parts, such as leaves, thereby affecting the photosynthetic activity of the plant. The scientific literature is rich in studies describing the intensity of the photosynthetic response to the amount of light that reaches the foliage for most agricultural crops.

One major problem in implementing solar energy infrastructures in agricultural areas is the lack of knowledge and implementation methodologies.

There therefore remains an unmet need to provide systems and methods for improving crop photosynthesis and deploying solar energy-driven systems synergistically with the crops.

There also remains an unmet need to provide systems and methods for maximizing electricity generation from solar energy systems and devices, while optimizing solar radiation to a crop in vicinity thereof.

### SUMMARY OF THE INVENTION

It is an object of some aspects of the present invention to provide novel systems and methods for improved solar energy utilization by deploying a solar energy-driven apparatus within an agricultural environment.

It is another object of some aspects of the present invention to provide improved, optimized systems and methods for combining solar energy-driven apparatus with growing photosynthetic crops.

It is another object of some aspects of the present invention to provide improved, optimized systems and methods for combining solar energy systems for generating electricity deployed outdoors in a place for growing photosynthetic crops concurrently.

It is another object of some aspects of the present invention to provide improved systems and methods for generating electricity from solar panels in combination with growing a photosynthetic crop at the same location without competing for or reducing the quantity of the solar radiation, incident on the solar panels.

It is another object of some aspects of the present invention to provide improved systems and methods for generating electricity from rows of solar panels inter-dispersed with rows of photosynthetic crops at the same location.

The present invention provides methods and systems for concurrent photosynthetic crop and electricity production at an outdoor location, the system including at least one solar energy apparatus comprising at least one row of solar panels, such as, but not limited to, photovoltaic panels, deployed at the outdoor location to absorb the solar energy from the sun and a processor configured to activate an algorithm for dynamic control of a shading level and shading location by moving the solar panels of the at least one row of solar panels deployed at a height above the ground at the outdoor location in a vicinity of the photosynthetic to dynamically change a quantity and location of solar radiation over time, provided to the photosynthetic crop and to generate the electricity production simultaneously.

The present invention provides methods and systems for photosynthetic crop production in an outdoor location, the system including at least one solar energy-driven apparatus comprising at least one solar panel, deployed at the outdoor location and a processor configured to activate an algorithm for dynamic control of at least one of a shading level of the at least one solar panel in the outdoor location by the at least one solar panel to dynamically change the location of the solar panels and as a result the quantity of solar radiation over time, provided to the photosynthetic crop.

The present invention provides methods and systems for photosynthetic crop production in an outdoor location, the system including at least one solar energy-driven apparatus comprising at least one solar panel, deployed at the outdoor location at a height greater than that of the photosynthetic crop and a processor configured to activate an algorithm for dynamic control of an adjustable position of shade from said at least one solar panel at the outdoor location to dynamically control a quantity of solar radiation, provided to the photosynthetic crop.

The present invention provides methods and systems for photosynthetic crop production in an outdoor location, the system including at least one solar energy-driven apparatus comprising at least one solar panel row, deployed at the outdoor location at a height greater than that of the photosynthetic crop and a processor configured to activate an algorithm for dynamic control of an adjustable position of shade from said at least one solar panel row at the outdoor location to dynamically control a quantity of solar radiation over time, provided to the photosynthetic crop.

The present invention provides dynamically sun tracking methods and systems for photosynthetic crop production in an outdoor location, the system including at least one solar energy-driven apparatus comprising at least one solar panel row, deployed at the outdoor location at a height greater than that of the photosynthetic crop and a processor configured to activate an algorithm for dynamic control of an adjustable position of shade from said at least one solar panel row at the outdoor location to dynamically control a quantity of solar radiation over time, provided to the photosynthetic crop.

The present invention provides dynamically sun tracking methods and systems for photosynthetic crop production in an outdoor location, the system including at least one solar energy-driven apparatus comprising at least one solar panel row, at the outdoor location at a height greater than that of the photosynthetic crop and a processor configured to activate an algorithm for dynamic control of an adjustable position of shade from said at least one solar panel row at the outdoor location to dynamically control a quantity of solar radiation over time, provided to the photosynthetic crop.

The present invention provides an agri-voltaic system for electricity and a photosynthetic crop production at an outdoor location, the system comprising:
a) at least one solar energy-driven apparatus comprising at least one solar panel, such as a photovoltaic panel, deployed above a ground level at the outdoor location; and
b) a processor configured to activate an algorithm for dynamic control of movement of said at least one solar panel to control shading by said at least one solar panel at said outdoor location to dynamically change a quantity of solar radiation over time to said photosynthetic crop.

The present invention provides a method for electricity and a photosynthetic crop production at an outdoor location, the method comprising:
a) generating electricity from at least one solar energy-driven apparatus comprising at least one solar panel, deployed above a ground level at the outdoor location; and
b) controlling shading by said at least one solar panel at said outdoor location to dynamically change a quantity of solar radiation over time to said photosynthetic crop.

The present invention provides a method for electricity and a photosynthetic crop production at an outdoor location, the method comprising:
a) generating electricity from at least one solar energy-driven apparatus comprising rows of solar panels, deployed above a ground level at the outdoor location;
b) deploying said rows of solar panels at a first height at the outdoor location; and
c) controlling shading by said rows of solar panels at said outdoor location to dynamically change a quantity of solar radiation over time to said photosynthetic crop.

The present invention provides a method for solar energy utilization and photosynthetic crop production at an outdoor location, the method comprising:
a) generating electricity from solar energy using at least one solar energy-driven apparatus comprising rows of solar panels, deployed above a ground level at the outdoor location;
b) deploying said rows of solar panels at a first height at the outdoor location to receive said solar energy;
c) moving said rows of solar panels responsive to an azimuth and elevation of the sun to improve said solar energy utilization; and
d) controlling shading by said rows of solar panels at said outdoor location to dynamically change a quantity of solar radiation over time to said photosynthetic crop.

The present invention provides a method for solar energy utilization and photosynthetic crop production at an outdoor location, the method comprising:
a) generating electricity from solar energy using a solar energy-driven apparatus comprising rows of solar panels, the solar panels deployed above a ground level at the outdoor location;
b) deploying said rows of solar panels at a first height at the outdoor location to receive said solar energy;
c) moving said rows of solar panels responsive to an azimuth of the sun to improve said solar energy utilization; and
d) controlling shading by said rows of solar panels at said outdoor location to dynamically change a quantity of solar radiation over time to said photosynthetic crop, wherein said photosynthetic crop is selected from a tree, a vine and a plant.

According to some embodiments, the crop is grown in rows with spacer rows there-between, also termed herein “service passages”.

According to some embodiments, the solar panels are deployed perpendicularly to the crop direction of growth.

According to some embodiments, the solar panels rows move perpendicularly to the tree rows.

According to some embodiments, at least some of the shade from said at least one solar panel falls on the spacer rows.

According to some embodiments, the majority of the shade from said at least one solar panel falls on the spacer rows.

According to some embodiments, all of the shade from said at least one solar panel falls on the spacer rows.

According to some embodiments, the algorithm ensures that the photosynthetic crop is not overheated.

According to embodiments, the algorithm ensures that the photosynthetic crop receives sufficient photosynthetic radiation.

According to some embodiments, the algorithm ensures that the photosynthetic crop is protected from hail, rain, wind, heat, dust, cold and frost.

According to some embodiments, the crop is grown in an orchard, vineyard, plantation or field.

According to some embodiments, the crop is selected from a tree, a fruit tree, a vine, a banana plant or an edible crop.

According to some embodiments, the crop grows in rows with spacer rows between the crop rows.

According to some embodiments, the spacer rows have a width equal or greater to the crop row width.

According to some embodiments, at least one solar panel comprises a plurality of solar panels.

According to some embodiments, the plurality of solar panels is deployed in rows above at least one of the crop rows and the spacer rows.

According to some embodiments, the plurality of solar panels is deployed partially or wholly above the spacer rows.

According to some embodiments, the solar panel rows are deployed horizontally.

According to some embodiments, the solar panel rows are partially deployed horizontally with a degree of freedom about a vertical axis to form an acute angle of elevation with the vertical axis

According to some embodiments, the solar panels are double sided (bifacial) panels.

According to some embodiments, the rows of solar panels are suspended on a mechanical system of rails at a height H1 above the ground. Optionally, the solar panels are suspended using a cable car.

According to some embodiments, the crop grows to a height H2 above the ground, wherein H2 is less than H1.

According to some embodiments, a width of a spacer row is W1.

According to some embodiments, a width of a row of a crop is W2.

According to some embodiments, W1 is greater than W2.

According to some embodiments, the systems and methods of the present invention prevent the crop from receiving solar radiation in excess of a critical radiation level.

According to some embodiments, the systems and methods of the present invention enable the crop to receive solar radiation during sunlight hours of up to a critical radiation level.

According to some embodiments, the systems and methods of the present invention enable a crop to:
a) generate electricity during sunlight hours independent of the location of the solar panels relative to the crop;
b) in many cases, provide the crop with solar radiation without competing for or reducing the quantity of the solar radiation, incident on the solar panels;
and
c) does not limit the orientation of the crop to north-south.

In some embodiments of the present invention, improved methods and apparatus are provided for synergistically combining solar energy apparatus with photosynthetic plant generation and optionally, plant protection.

In further embodiments of the present invention, a method and system are disclosed for providing optimized agricultural growing methods and systems which input into a control system for positioning of at least one solar energy-driven apparatus.

In yet further embodiments of the present invention, a method and system are disclosed for providing optimized agricultural growing methods and systems which input into a control system for positioning of at least one solar energy photovoltaic panel apparatus.

In other embodiments of the present invention, a method and system are described for providing optimized crop production in conjunction with solar energy-driven apparatus.

In additional embodiments for the present invention, there is provided An agri-voltaic system for photosynthetic crop production in an outdoor location, the system comprising:
a) at least one solar energy-driven apparatus comprising at least one solar panel, deployed at the outdoor location;
b) a processor configured to activate an algorithm for dynamic control of at least one of a shading level of said at least one solar panel in said outdoor location by said at least one solar panel to dynamically change a quantity of solar radiation over time to said photosynthetic crop.

In further embodiments of the present invention, the at least one solar energy-driven apparatus comprises at least one solar photovoltaic panel apparatus.

In yet further embodiments of the present invention, the system further comprises at least one adjustable support for the at least one solar photovoltaic panel apparatus.

In yet further additional embodiments of the present invention, the at least one adjustable support is moved at least one of horizontally, vertically and at an angle to the horizontal relative to a static position of said photosynthetic crop.

In yet further embodiments of the present invention, the system and methods prevent solar damage to the photosynthetic crops.

Moreover, according to an embodiment of the present invention, the systems and methods of the present invention can prevent at least one of:
a) heat damage;
b) excess solar radiation damage;
c) rain damage;
d) snow damage; hail damage to the crop; and
e) frost/cold damage.

In further embodiments of the present invention, the system further comprises IoT (internet of things) Radiation & Micro-climate Sensors.

### EMBODIMENTS

1. An agri-voltaic system for improved crop protection in an orchard, the system comprising:
a) at least one solar energy apparatus comprising at least one photovoltaic cell and at least one row of solar panels, deployed in the orchard to capture/absorb the solar radiation from the sun; and
b) a processor configured to activate an algorithm for dynamic control of a position of incidence of shading from said at least one row of solar panels on ground parallel to at least one rows of trees.

2. An agri-voltaic system according to embodiment 1, wherein said shading from said at least one row of solar panels falls at least partially on said at least one parallel passage on said ground parallel to said at least one row of trees.

3. An agri-voltaic system according to embodiment 1, further comprising a suspension apparatus for suspending said at least one row of solar panels at a height above and parallel to said rows of trees, the suspension apparatus comprising:
i. at least one vertical support element for supporting said at least one row of solar panels at said height; and
ii. at least one movable element for horizontally moving said at least one row of solar panels at said height.

4. An agri-voltaic system according to embodiment 1, further comprising at least one DC: AC current inverter.

5. An agri-voltaic system according to embodiment 1, further comprising IOT radiation and micro-climate sensors.

6. An agri-voltaic system according to embodiment 1, wherein said at least one solar energy apparatus further comprises at least one horizontally movable panel support.

7. An agri-voltaic system according to embodiment 1, wherein said at least one solar energy apparatus further comprises at least one panel tilt angle moving element configured to tilt said at least one row of solar panels according to instructions received from said processor.

8. An agri-voltaic system according to embodiment 8, wherein said instructions are determined by said algorithm.

9. An agri-voltaic system according to embodiment 1, wherein said at least one row of solar panels comprises a plurality of rows of solar panels.

10. An agri-voltaic system according to embodiment 9, wherein said plurality of rows of solar panels is deployed at a distance from and height above said rows of trees.

11. An agri-voltaic system according to embodiment 10, wherein said distance and said height is determined by growth parameters of said trees.

12. An agri-voltaic system according to embodiment 11, wherein said at least one moveable element comprises at least one wheel in mechanical connection with said at least one horizontally movable panel support.

13. An agri-voltaic system according to embodiment 12, wherein said algorithm is further configured to dynamically control an area of incidence of shading from said at least one row of solar panels.

14. An agri-voltaic system according to embodiment 1, wherein a distance from a center of two adjacent rows of trees is equal to a distance between two adjacent rows of solar panels.

15. An agri-voltaic system according to embodiment 12, further comprising a set of rails for supporting said at least one wheel.

16. An agri-voltaic system according to embodiment 12, further comprising a set of pulleys for supporting said at least one wheel.

17. A method for improved solar energy capture in an orchard, the method comprising:
a) deploying at least one solar energy-driven apparatus comprising at least one row of solar panels at a height above and at a distance from at least one row of trees in the orchard; and
b) activating an algorithm to dynamically control a position of incidence of shading from said at least one row of solar panels onto ground parallel to at least one row of trees.

18. A method according to embodiment 17, wherein said shading from said at least one row of solar panels falls at least partially on said at least one parallel passage on said ground parallel to said at least one row of trees.

19. A method according to embodiment 17, further comprising dynamically controlling a micro-climate in a vicinity of said photosynthetic crop over time.

20. A method according to embodiment 17, further comprising inverting said energy from at least one photovoltaic cell in said at least one solar energy-driven apparatus from DC to AC.

21. A method according to embodiment 17, further comprising tilting at least one solar panel to induce said shading.

22. A method according to embodiment 19, wherein said tilting is in accordance with instructions determined by an algorithm.

23. A method according to embodiment 17, wherein said at least one row of solar panels comprises a plurality of rows of solar panels.

24. A method according to embodiment 17, wherein said area of incidence of shading falls on ground in between rows of said crop.

25. A method according to embodiment 17, wherein said at least one row of trees comprises a plurality of rows of trees.

26. A method according to embodiment 25, wherein said a plurality of rows of trees are inter-disposed with said plurality of rows of solar panels.

27. A method according to embodiment 25, wherein a number of said rows of said solar panels is greater or equal to a number of said rows of said trees.

28. A method according to embodiment 25, wherein said rows of solar panels are disposed at a height above said rows of trees.

29. A method according to embodiment 25, wherein a distance from a center of two adjacent rows of trees is equal to a distance between two adjacent rows of solar panels.

30. A method for optimizing utilization of solar radiation at an outdoor location in an orchard, the method comprising:
a) deploying at least one solar energy apparatus comprising a plurality of rows of solar panels at the outdoor location to absorb solar radiation, wherein said rows of solar panels are deployed in parallel to rows of trees in said orchard;
b) generating electrical energy from said plurality of rows of solar panels in electrical connection with at least one photovoltaic cell;
c) partially shading said rows of trees with said plurality of rows of solar panels if said solar radiation level is equal to or above said first threshold and below a second threshold; and optionally
d) fully shading said rows of trees with said plurality of rows of solar panels, if said solar radiation level greater than said second threshold.

31. A method according to embodiment 30, wherein said plurality of rows of solar panels move to protect said rows of trees from hail, rain, snow, wind, heat, dust, cold or frost.

32. An agri-voltaic system according to embodiment 1, wherein the solar energy apparatus is deployed on at least one of:
i. at least one cable;
ii. at least one rail; and
iii. at least one mechanical moveable support,
   whereby the apparatus is operative to control full or partial shading of the photosynthetic crop.

33. An agri-voltaic system according to embodiment 31, wherein said at least one cable or said at least one rail enables said at least one row of solar panels to slide horizontally above said photosynthetic crop.

34. An agri-voltaic system according to embodiment 31, wherein said at least one row of solar panels is deployed between rows of said trees.

35. An agri-voltaic system for improved utilization of an outdoor location, the system comprising:
a) a solar energy apparatus comprising at least one photovoltaic cell and at least one row of solar panels, in electrical connection with said at least one photovoltaic cell, deployed at the outdoor location to absorb solar radiation;
b) a suspension apparatus for suspending said at least one row of solar panels at a height above said photosynthetic crop, the suspension apparatus comprising:
   i. at least one vertical support element for supporting said at least one row of solar panels at said height; and
   ii. at least one movable element for horizontally moving said at least one row of solar panels at said height;
c) at least one sensor for detecting at least one of a local temperature, a solar panel position, a level of solar radiation and a micro-climate parameter; and
d) a processor configured to receive inputs from said at least one sensor and to activate an algorithm for dynamic control of a quantity of solar radiation over time to said photosynthetic crop and further to control at least one of i) a position of incidence of shading from said at least one row of solar panels and ii) a level of shading to said photosynthetic crop by said at least one row of solar panels,
thereby enabling concurrent improved photosynthetic crop production and solar energy utilization at said outdoor location.

36. An agri-voltaic system for improved electricity production at an orchard, the system comprising:
a) at least one solar energy apparatus comprising a plurality of rows of solar panels, deployed-horizontally to absorb solar radiation at a height above and between a plurality of rows of trees in the orchard;
b) at least one photovoltaic cell for receiving energy from said a plurality of rows of solar panels and converting said energy into electricity;
c) a suspension apparatus for suspending said plurality of rows of solar panels, the suspension apparatus comprising:
   i. at least one vertical support element for supporting said plurality of rows of solar panels at said height; and
   ii. at least one movable element for horizontally moving said plurality of rows of solar panels at said height;
d) at least one sensor for detecting at least one of a local temperature, a row of solar panels position, a level of solar radiation and a micro-climate parameter, and
e) a processor configured to receive inputs from said at least one sensor and to activate an algorithm for at least one of dynamic;
   i. horizontally moving said plurality of rows of solar panels; and
   ii. turning said plurality of rows of solar panels about an axis,
thereby improving incidence of solar radiation to said plurality of rows of solar panels.

37. An agri-voltaic system for shade control in an orchard, the system comprising:
a) at least one row of shading panels; and
b) a processor configured to activate an algorithm for dynamic control of a position of incidence of shading from said at least one row of shading panels and on ground parallel to at least one row of trees in said orchard.

38. An agri-voltaic system according to embodiment 1, wherein said algorithm is further configured to move said at least one row of solar panels move to protect said at least one rows of trees from hail, rain, snow, wind, heat, dust, cold or frost.

39. An agri-voltaic system according to embodiment 1, wherein said at least one row of solar panels is configured for horizontal movement in a direction perpendicular to trees in said at least one rows of trees, wherein said at least one row of solar panels is further configured to cast its shade onto at least one passage between tree rows in order that the photosynthetic crops will be exposed to direct sun.

40. An agri-voltaic system according to embodiment 1, wherein said at least one row of solar panels is configured for horizontal movement in a direction perpendicular to trees in said at least one rows of trees, wherein said at least one row of solar panels is further configured to cast its shade onto at least one passage between tree rows in order that the photosynthetic crops will be exposed to direct sun.

41. An agri-voltaic system according to embodiment 1, wherein said at least one row of solar panels is configured for horizontal movement in a direction perpendicular to trees in said at least one rows of trees, wherein said at least one row of solar panels is further configured to cast its shade onto said at least one rows of trees in order protect the trees or crops from extreme weather conditions.

42. An agri-voltaic system according to embodiment 40 further comprising single-axis (rotational) sun tracking apparatus.

The present invention will be more fully understood from the following detailed description of the preferred embodiments thereof, taken together with the drawings.

### BRIEF DESCRIPTION OF THE DRA WINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

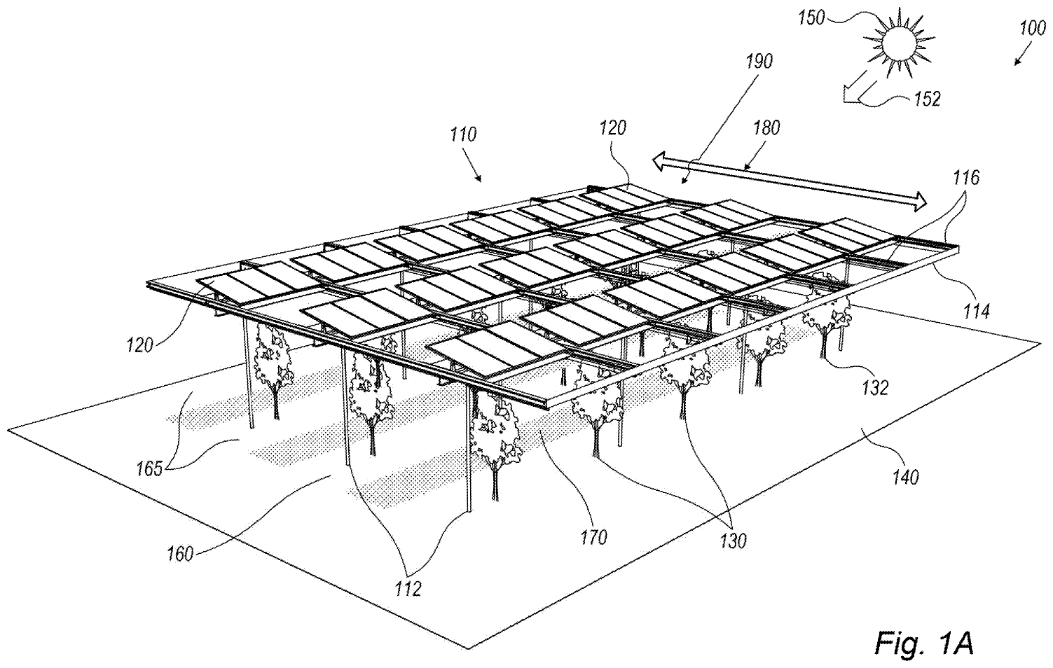

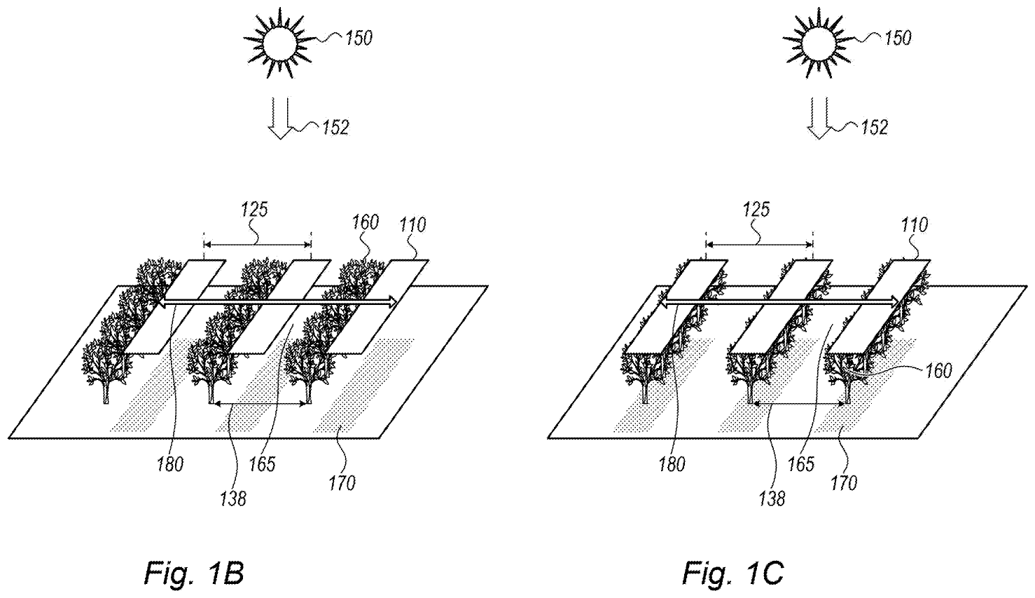

FIG. 1A is a simplified pictorial illustration showing an agri-voltaic system for optimizing photosynthetic crop production at an outdoor location, in accordance with an embodiment of the present invention;

FIG. 1B is a simplified pictorial illustration showing an agri-voltaic system for optimizing shade control in an orchard, in accordance with an embodiment of the present invention;

FIG. 1C is another simplified pictorial illustration showing an agri-voltaic system for optimizing shade control in an orchard, in accordance with an embodiment of the present invention;

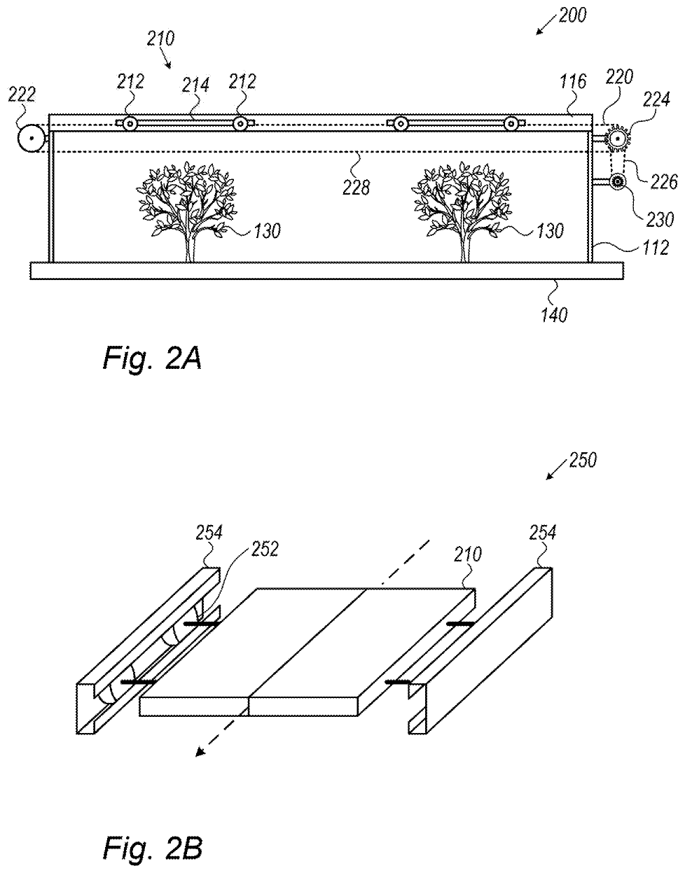

FIG. 2A is a simplified pictorial illustration showing a side view of a suspension apparatus for at least one solar panel, in accordance with an embodiment of the present invention;

FIG. 2B is a simplified schematic illustration showing a perspective view of a mechanical apparatus for moving at least one solar panel, in accordance with an embodiment of the present invention;

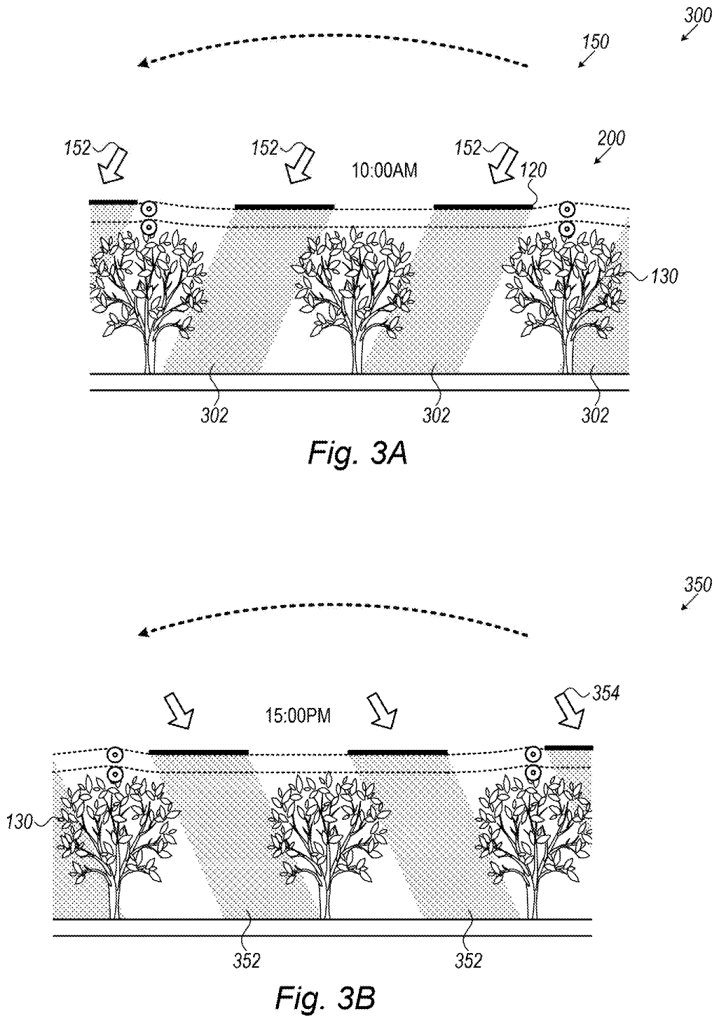

FIG. 3A is a simplified pictorial illustration showing a suspension apparatus for solar tracking of at least one solar panel with little or no crop shading on crop trees (morning), in accordance with an embodiment of the present invention;

FIG. 3B is a simplified pictorial illustration showing a suspension apparatus for solar tracking of at least one solar panel with little or no crop shading on crop trees (afternoon), in accordance with an embodiment of the present invention;

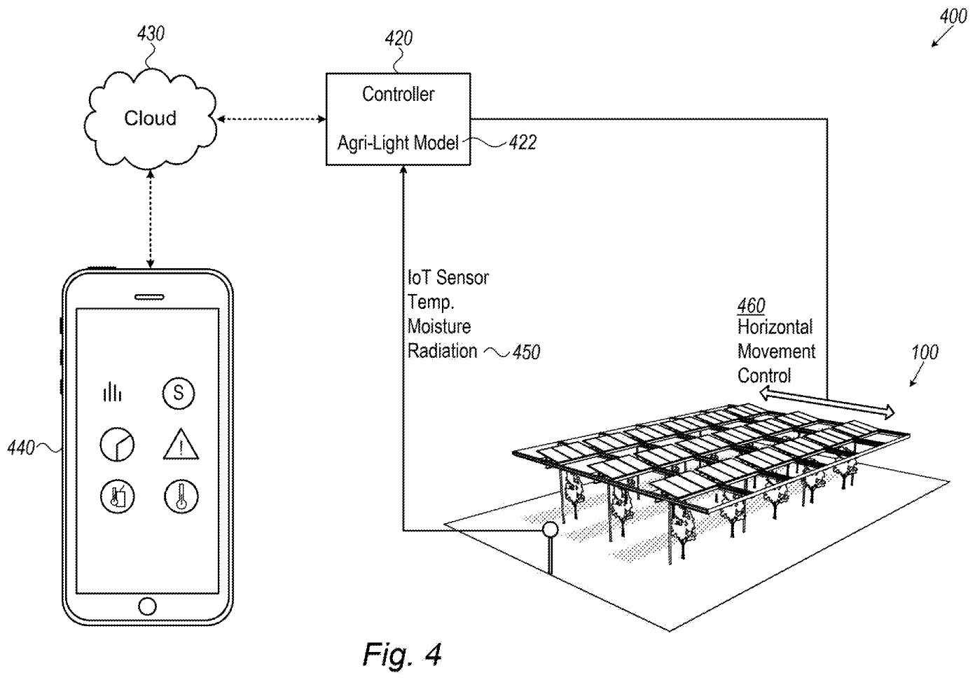

FIG. 4 is a simplified pictorial illustration showing an agri-voltaic system for dynamic control and optimization of photosynthetic crop production at an outdoor location, in accordance with an embodiment of the present invention;

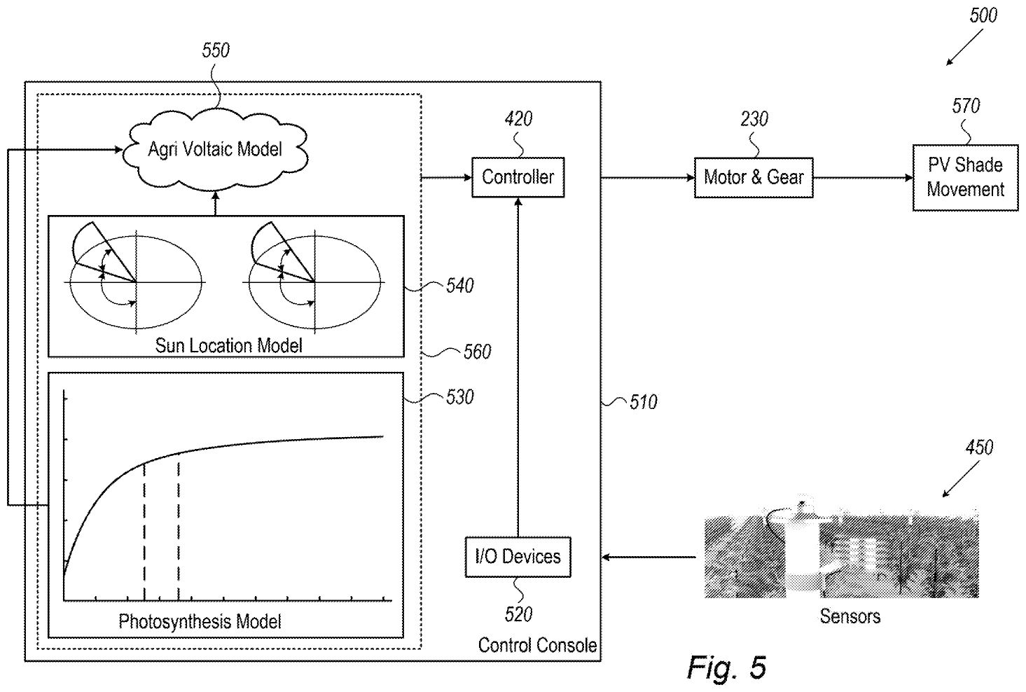

FIG. 5 is a simplified pictorial illustration showing an agri-voltaic system for dynamic control and optimization of—shading in photosynthetic crop production at an outdoor location, in accordance with an embodiment of the present invention;

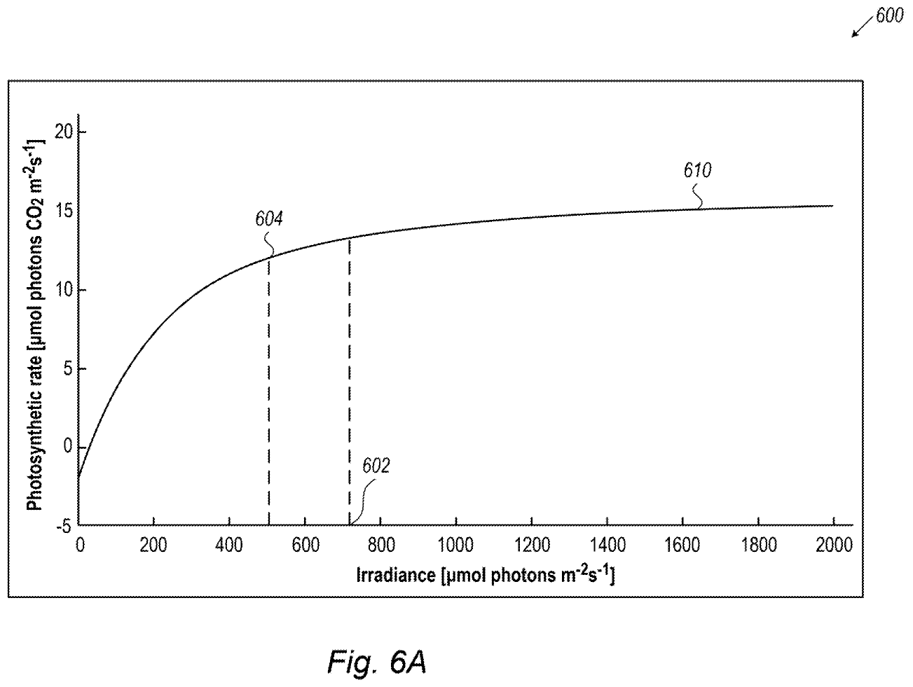

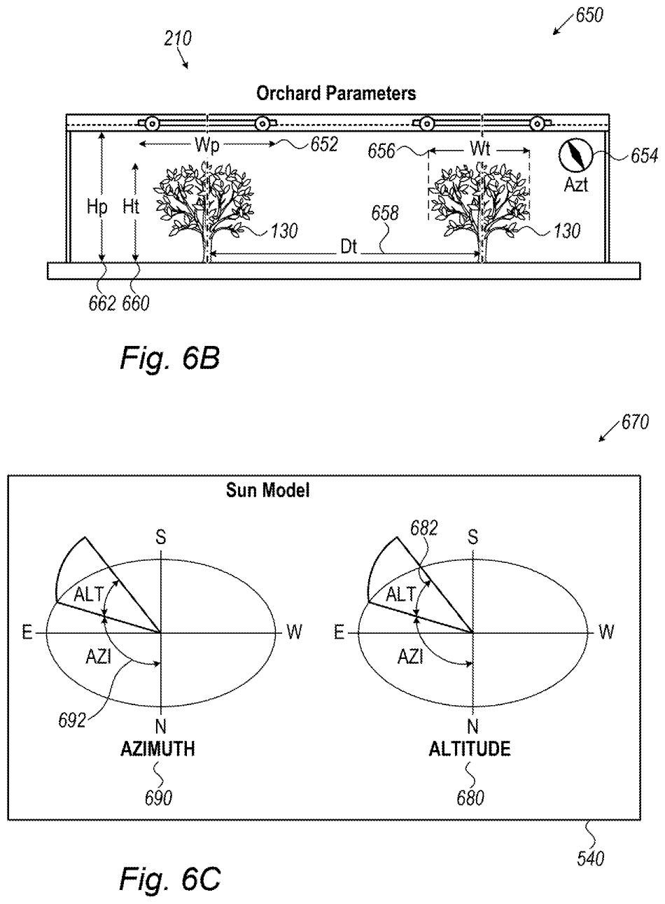

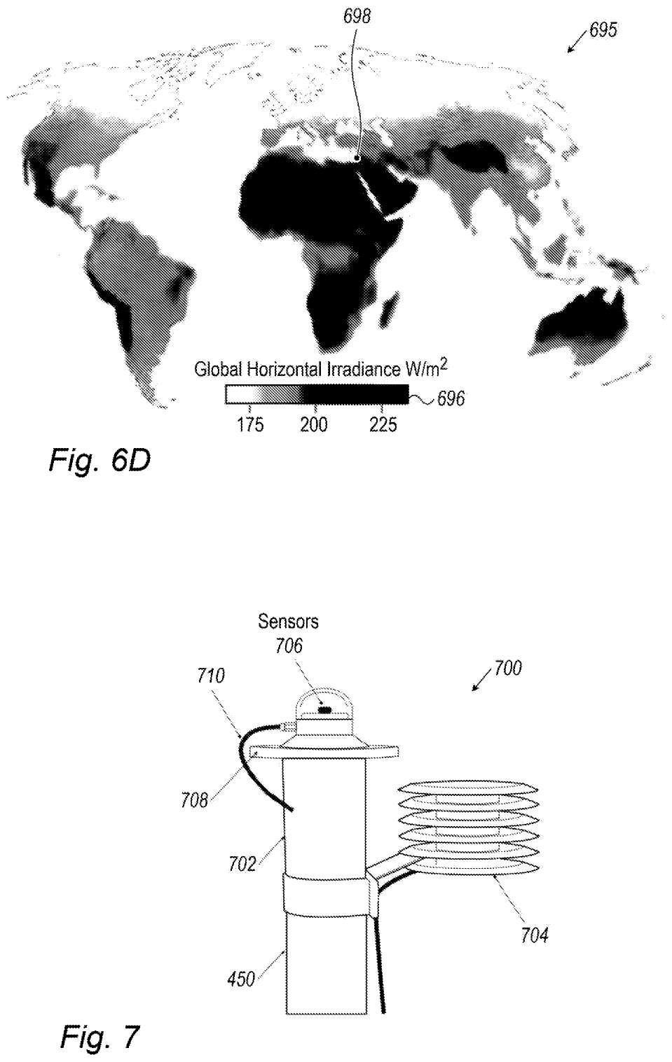

FIG. 6A shows a simplified graph of solar irradiance versus a crop photosynthetic rate, in accordance with an embodiment of the present invention;

FIG. 6B shows a simplified pictorial illustration of photosynthetic crop parameters used in a dynamic control and optimization model for photosynthetic crop production and photovoltaic energy generation, in accordance with an embodiment of the present invention;

FIG. 6C is a simplified schematic illustration showing solar parameters used in an optimization model for photosynthetic crop production and photovoltaic energy generation, in accordance with an embodiment of the present invention;

FIG. 6D is a simplified schematic illustration showing geographic parameters used in an optimization model for photosynthetic crop production and photovoltaic energy generation, in accordance with an embodiment of the present invention;

FIG. 7 is a simplified pictorial illustration of an IoT sensor in the system of FIG. 1, in accordance with an embodiment of the present invention;

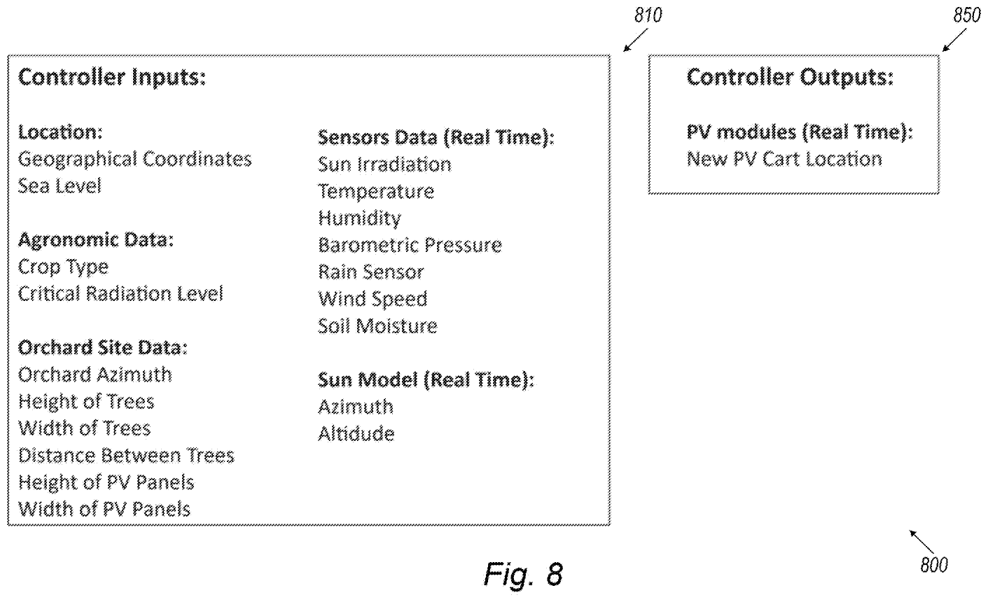

FIG. 8 shows a simplified table of input and output used in a dynamic control and optimization model algorithm for photosynthetic crop production and photovoltaic energy generation, in accordance with an embodiment of the present invention;

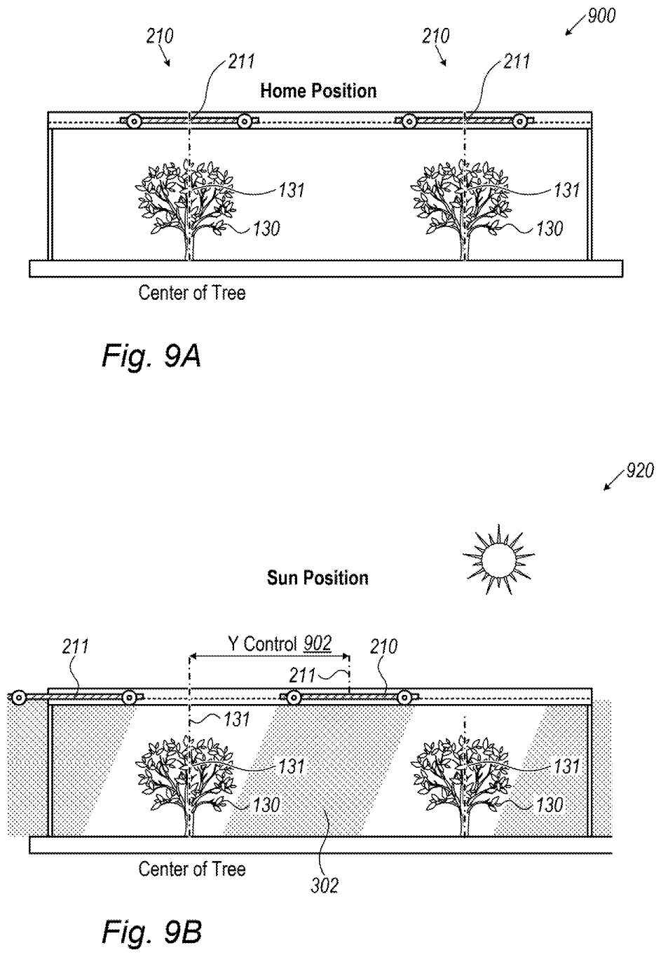

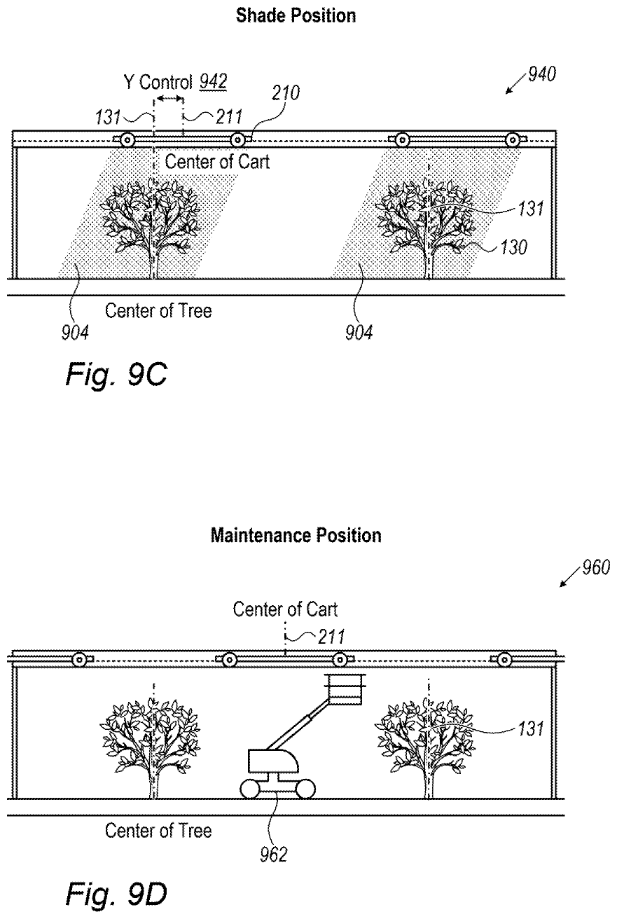

FIG. 9A is a simplified pictorial illustration of a side view of the suspension apparatus of FIG. 2A in a “Home position”, in accordance with an embodiment of the present invention;

FIG. 9B is a simplified pictorial illustration of a side view of the suspension apparatus of FIG. 2A in a “Sun position”, in accordance with an embodiment of the present invention;

FIG. 9C is a simplified pictorial illustration of a side view of the suspension apparatus of FIG. 2A in a “Shade position”, in accordance with an embodiment of the present invention;

FIG. 9D is a simplified pictorial illustration of a side view of the suspension apparatus of FIG. 2A in a “Maintenance position”, in accordance with an embodiment of the present invention;

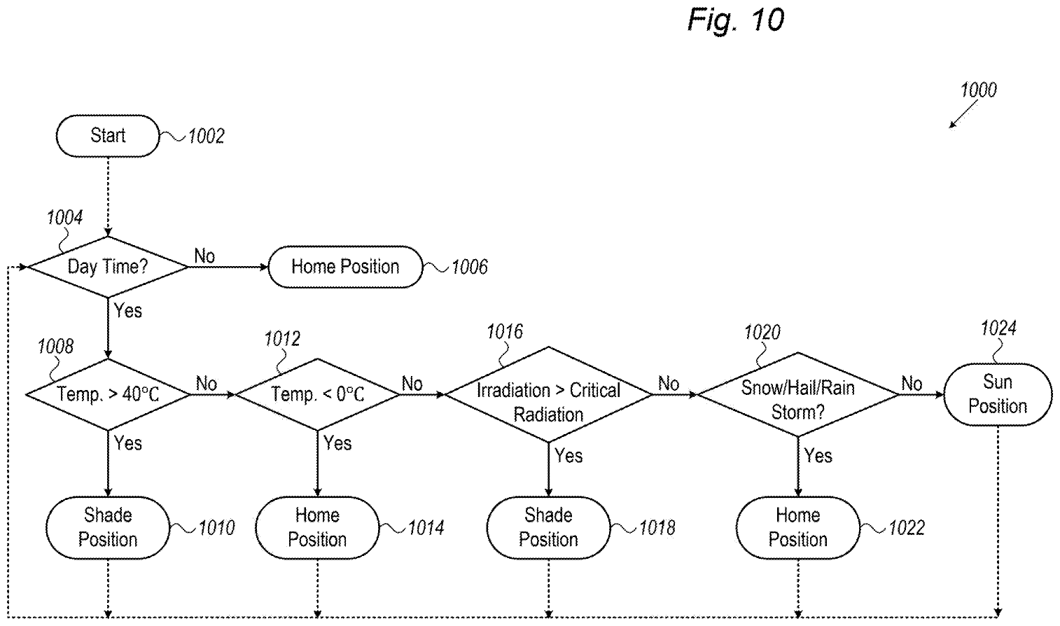

FIG. 10 is a simplified flowchart of a method for optimizing photosynthetic crop production and photovoltaic energy generation outdoors, in accordance with an embodiment of the present invention;

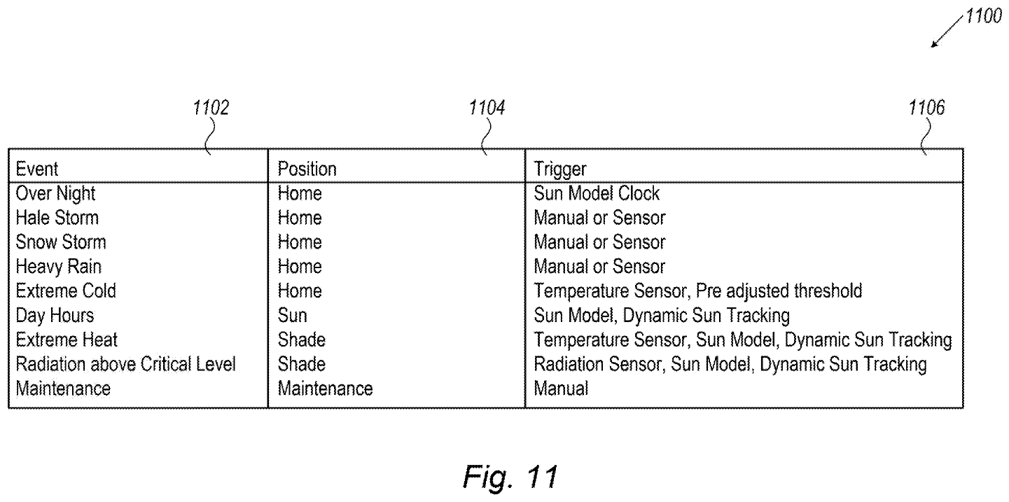

FIG. 11 is a simplified table of decision making for solar panel position in the method of FIG. 10, in accordance with an embodiment of the present invention;

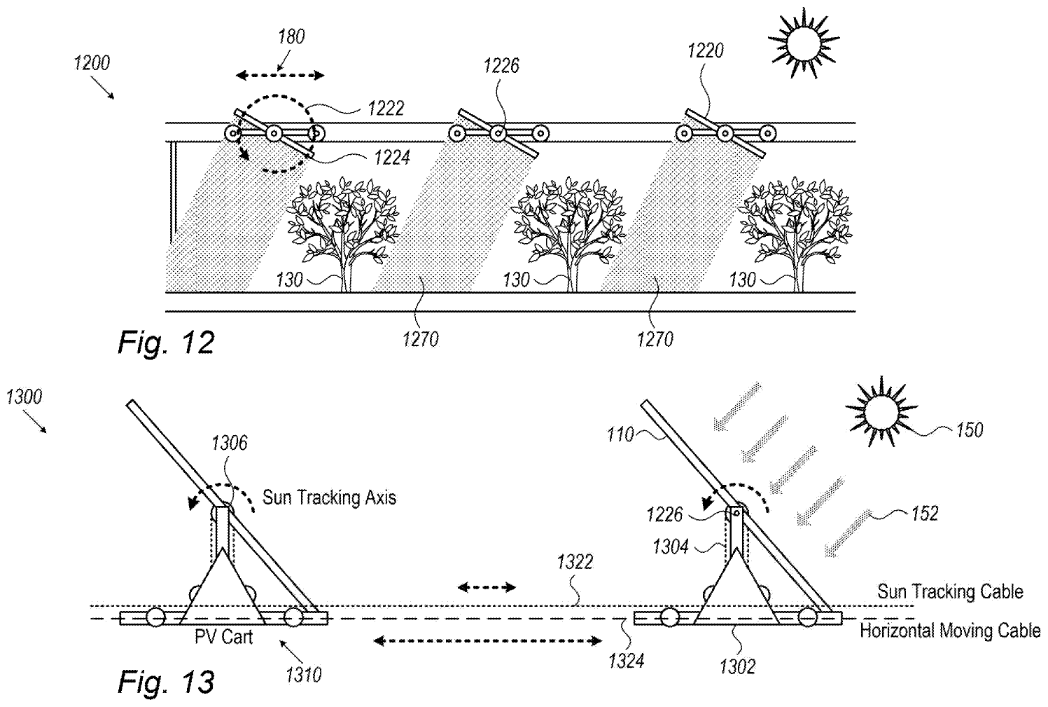

FIG. 12 is a simplified pictorial illustration showing a side view of a suspension apparatus with solar panel rotation, in accordance with an embodiment of the present invention; and

FIG. 13 is a simplified pictorial illustration showing a side view of a sun-tracking suspension apparatus with solar panel rotation, in accordance with an embodiment of the present invention.

In all the figures similar reference numerals identify similar parts.

### DETAILED DESCRIPTION OF THE EMBODIMENTS OF THE INVENTION

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

Reference is now made to FIG. 1A, which is a simplified pictorial illustration showing an agri-voltaic system 100 for optimizing photosynthetic crop production and photovoltaic energy production outdoors, in accordance with an embodiment of the present invention.

System 100 is an agri-voltaic system, which is particularly suitable for plantations/orchards 130 and for tree growth. What characterizes the plantations is an enclosed array of rows 160 of trees or crops, with relatively wide service passages 165 that allow the passage of agricultural/other vehicles (not shown) between the rows.

The agri-voltaic system is characterized by an array of rows 110 of solar photo-voltaic (PV) panels 120 assembled on top of a mechanical support structure 190 above the trees. The structure is often several meters high, such as at least 2, 3, 4, 5, 6, 7, 8, 9 or 10 meters high.

The mechanical structure 190 typically comprises a number of equi-spaced vertical supports 112, horizontal widthwise structural beams 114 and lengthwise horizontal rails 116, generally perpendicular to the horizontal widthwise beams 114. In some cases, the beams and rails may be replaced by other suitable support structures. The rows of solar panels are moved mechanically, as is seen in further detail with respect to FIGS. 1, 2A, 2B, 12-13, for example.

System 100 is constructed and configured for improved, optimal growth of the plantation/crop there-below, while allowing for energy production by the PV panels. The PV panels are disposed to receive solar energy from sunrays/beams 152 from the sun 150. The rows of panels also provide rows of shade 170 on the ground 140.

System 100 is generally constructed and configured to allow:

The rows of solar panels to be parallel to the rows of trees and therefore the shade from these panels will always be parallel to the rows of trees;

The distance 125 between the center of the rows of panels must be equal to the distance 165 between the rows of trees;

The solar panels have the ability to be moved horizontally, for example by transporting wheels on rails (or other mechanical configurations, such as a cable car).

The horizontal movement direction 180, is designed to be perpendicular to the direction of the rows of trees.

The pillars of the construction (vertical supports 112) stand between the rows of trees so as not to block the passages between the rows.

The horizontal movement is controlled by a control system 420 (FIGS. 4-5) that controls a motor 230 (FIG. 2A) that drives the panels horizontally on the rails 116.

The control system is constructed and configured with an algorithm (model) that includes, among other things, the momentary position of the sun (Azimuth 692 and Altitude 682 (FIG. 6C), according to which the controller controls the position of the panels on the tracks and therefore also the position of the shadow from the solar panels.

The system in the configuration described herein ensures that the trees receive the maximum available level of solar radiation they need for photosynthesis processes with no or very little shading.

The system further protects trees in extreme weather conditions, like, high temperatures, low temperatures (frost) and rain, hail or snow storms.

This system combines “dual-use” in the same land resource for both agriculture and solar power generation without harming agriculture. In this system there is no competition for solar radiation between the needs of agriculture (crop/trees/plantation) and solar PV systems. The systems of the present invention are constructed and configured to improve the yield of electricity without harming the agricultural crop, due to excess solar radiation and or extreme weather conditions.

The solar panels prevent solar damage to the photosynthetic crops by providing at least one of full shading and partial shading at different times of the day. The solar panels are typically supported by at least one mechanical support. The mechanical support may be of a height of at least one, two, three, four, five or six meters above the ground (or more). Moreover, the mechanical support may be connected to electronic apparatus, such as a motor, for moving the solar panels on rails, regardless of PV panel tilt angle that can be—horizontal, vertical or at any angle to the ground.

In some embodiments, the solar panels may fully or partially cover the crop for some/all of the sunlight hours.

FIG. 1B and FIG. 1C schematically describe the concept of shade control, the shade 170 from panel rows 110 can falls for a certain horizontal movement 180 position of the solar panels 110, on service passages 165, in this case the tree rows 160 are fully exposed to sunrays 152 and the trees 160 are getting the necessary radiation for the photosynthetic process. On the other hand the shade 170 from panel rows 110 can falls for a different horizontal movement 180 position of the solar panels 110, on the tree rows 160 to protect the tree rows from extreme weather conditions. A control algorithm (not shown here) dynamically control the direction and moving distance of the horizontal movement 180.

FIG. 1B and FIG. 1C describes the shade 170 position of solar panels rows 110 where sunrays 152 are in zenith position for different horizontal movement 180 distances.

In FIG. 1B the tree rows 160, are exposed to direct sunrays 152 and the shade 170 falls in the middle of service passages 165

In FIG. 1C the shade 170 falls on tree rows 160 and the service passages 165 are exposed to direct sun.

In order to implement this shade control concept for orchard, several configuration requirements must be met:
1. The array of rows 110 of solar photo-voltaic (PV) panels must be parallel to the rows 160 of trees.
2. The distance 125 between the centers of rows 110 of solar panels, must be equal to the distance 138 between the rows 160 of the trees.
3. The horizontal movement 180 direction of rows 110 of solar panels must be perpendicular to the rows 160 of trees.
4. The horizontal movement 180 of rows 110 of solar panels moves back and forth with a total moving distance that is equal to the distance 138 of the tree rows.

FIG. 2A is a simplified pictorial illustration showing a side view of a suspension apparatus 200 for at least one solar panel, in accordance with an embodiment of the present invention.

FIG. 2A schematically depicts the horizontal movement of the system. The picture depicts a cart (PV Cart) 210 carrying the solar panels 214. Each cart has wheels 212 that can move in or over rails 116 and allow the horizontal movement of the solar panels. Each cart has at least two rails. An electric motor (AC or DC) 230 with a gear 224 controlled by a control system (510, FIG. 5) drives the cart using wheels and cables/chains 220, 222, 226, 228 on the rails. The shade 170 from the solar panels also moves with the movement of the panels.

FIG. 2B is a simplified schematic illustration showing a perspective view of a mechanical apparatus 250 for moving at least one solar panel, in accordance with an embodiment of the present invention;

FIG. 2B schematically depicts one of the mechanical apparatus options for propelling the solar panel cart with wheels 252 moving within two parallel rails 254. The wheels roll on/inside the rails around an axis connected to the structure of the cart that carries the solar panels. Pulling the cart, is performed for example, using a cable pulled by a motor which propel the cart inside the rail.

FIG. 3A is a simplified pictorial illustration showing an agri-voltaic system 300 comprising suspension apparatus 200 for shade control by horizontal movement of at least one solar panel with little or no crop shading (morning), in accordance with an embodiment of the present invention. FIGS. 3A and 3B describe the principle of shade position management. The control system (510, FIG. 5) comprises a “Sun Model” algorithm that provides continuous control of data on the location of the sun (see also FIG. 6C), i.e. an azimuth 690 and altitude 680 of the sun in a geographical location defined in “Sun Model” 670.

The cart motion algorithm (not shown) calculates, using methods of spatial trigonometry, an optimal position of the panels on the rails so that the shade of the panels is cast on the service aisles or passages (rows of shade) 170 and allows direct sunlight/rays 152 to reach the trees. Of course, this position is dynamic and changes continuously depending on the momentary position of the sun.

FIG. 3A schematically shows the optimal position of the panels, say at 10:00 AM, and FIG. 3B schematically shows the optimal position, say at 15:00 PM.

FIG. 3B is a simplified pictorial illustration showing an agri-voltaic system 350 comprising suspension apparatus for solar tracking of at least one solar panel with little or no crop shading (afternoon) 352, in accordance with an embodiment of the present invention. Afternoon sunrays 354 fall directly on the rows of trees 130.

FIG. 4 is a simplified pictorial illustration showing an agri-voltaic system 400 for dynamic control and optimizing photosynthetic crop production and PV energy generation at an outdoor location, in accordance with an embodiment of the present invention.

FIG. 4 schematically describes the interface and architecture of the agri-voltaic system with a control system 420. A controller 510 (FIG. 5) continuously receives data of the real-time location of the sun 150 from a Sun Model 670 and from sensors 450 (such as radiation and temperature) the data of the ambient environment, as well as data of the microclimate in the vicinity of the agricultural crops 130. The data are collected and entered into as variables into the model (see FIG. 8 for input data) and control logic defined in the controller. The controller calculates the optimal position of the solar panels and provides a signal to motor 230 to move the panels applying horizontal movement control 460 to the optimal location. According to some embodiments of the present invention, the controller communicates with a communication cloud 430 and to an end user via a portable or static communication device 440.

FIG. 5 is a simplified pictorial illustration showing an agri-voltaic system 500 for control and optimizing shading in photosynthetic crop production and solar-generated electricity at an outdoor location, in accordance with an embodiment of the present invention.

FIG. 5 schematically depicts a control console 510 comprising the control components (I/O devices 520 that received data from sensors 450, a controller 420, a PV movement model 560, which receives inputs from an agri-voltaic model 550, a sun location model 540 and a photosynthesis model 530). The control console delivers instructions to motor 230 to move the panels optimally, thereby controlling the PV movement 570, to control the degree of sun radiation and shade provided to the crop/plantation.

Thus, the motor controls the position of the shade by horizontal movement of the solar panels. The agrivoltaic model calculates the optimal position of the solar panels. The controller provides the motor with the distance and direction the panels need to move, with the linear distance translated into the number of motor rotations and direction of rotation. The controller knows, at any time, the current position of the solar panels.

This may be achieved, for example through feedback, which it receives from an encoder (not shown) that counts the rotations of the motor, of course there are other ways that can be applied, for example using induction sensors (not-shown, induction) that allow in appropriate configurations to measure linear motion.

FIG. 6A shows a simplified graph 600 of solar irradiance versus a crop photosynthetic rate, in accordance with an embodiment of the present invention.

FIGS. 6A to 6D schematically describe the parameters used in a photosynthetic model 530 in control system 400.

FIG. 6A depicts the photosynthetic curve 610 of a plant. This curve describes the photosynthetic activity as a function of the level of radiation reaching the plant, it can be clearly seen that this curve reaches an optimal radiation level 604 from the sun. As the sun radiation increases, it saturates the photosynthetic ability of the plant until a “Critical Radiation Level” 602 is reached. Above this level of radiation, the plant may be damaged or even die from excess of solar radiation.

Each plant type has a separate and different curve, the agri-voltaic model 550 takes these data into account and the data impacts, in turn, on the PV movement model 560 to control PV movement 570 to control shading of the crop/plantation.

FIG. 6B shows a simplified pictorial illustration of photosynthetic crop parameters used in an optimization model 650 for photosynthetic crop production and photovoltaic energy generation, in accordance with an embodiment of the present invention. FIG. 6B schematically describes the physical dimensions of a crop, exemplified by an orchard and the agri-voltaic system. The parameters used in model 650 may include some or all of:
a) Plantation/orchard dimensions;
b) Geographical coordinates of the orchard (data for initializing the solar model);
c) Altitude above sea level of the orchard (data for initialization of the solar model);
d) The type of growth/crop 130 and its critical level of radiation 602;
e) A distance between the trees (Dt 658);
f) A height of the trees (Ht, 660);
g) A width of the foliage footprint of the trees (Wt 656);
h) An azimuth 654 of the rows of trees;
i) A width 652 of panel 210 (and optionally other dimensions of the agri-voltaic system 100, not shown); and
j) A height of the panels from the ground (Hp, 662).

FIG. 6C is a simplified schematic illustration showing solar parameters used in a solar/sun optimization model 670 for photosynthetic crop production and photovoltaic energy generation, in accordance with an embodiment of the present invention. The solar/sun parameters include, but are not limited to, the current altitude of the sun 682, and the azimuth 692 of the sun, a geographic coordinates (latitude and longitude 698) and any other sun-related parameters.

FIG. 6D is a simplified schematic illustration showing geographic location parameters 695 used in an optimization model for photosynthetic crop production and photovoltaic energy generation, in accordance with an embodiment of the present invention. These may include a sun irradiance parameter 696 and a geographic location 698, as well as those mentioned hereinabove.

FIG. 7 is a simplified pictorial illustration of an IoT sensor 700 in system 100 of FIG. 1, in accordance with an embodiment of the present invention.

FIG. 7 describes an array of “precision agriculture” sensors 704, 706, 708 integrated with the agri-voltaic system. The sensors may be supported on a mechanical support 702 connect to the controller with data cables 710 via I/O cards or any other super-wired communication method such as WIFI or IoT (not shown).

These sensors may include any one or more of:
a. a radiometer (not shown);
b. a thermometer 712;
c. a wind speedometer 714;
d. a rain sensor 716;
e. an anemometer 718;
f. a humidity sensor 720;
g. a soil moisture sensor 722; and
h. others (not shown).

Some sensors provide inputs to the controller that takes into account the values obtained to find the optimal location of the solar panels and their shade.

The control system record sensors data and makes it possible to monitor all the measured parameters.

The agrivoltaic system 100 directly affects the amount of irrigation water required and provided to the crop, and the relevant controller and sensors may be connected to the irrigation systems and activated automatically.

FIG. 8 shows a simplified table 800 of input parameters 810 and output parameters 850 used in an optimization model algorithm for photosynthetic crop production and photovoltaic energy generation (such as, but not limited to, a PV movement model 560), in accordance with an embodiment of the present invention.

FIG. 8 shows in the table all the inputs needed for the control system and the Agrivoltaic model in order to dynamically and continuously calculate the optimal location of the solar panels and the shade they cast in order to get better with the agricultural crops without harming the solar power generation.

This data is divided into
i. Solar location data;
ii. Geographic location data;
iii. Agronomic data of the type of crop
iv. Data on the physical dimensions of the orchard; and
v. Continuous data from the sensors.

Based on these data, the agri-voltaic model 550 calculates the optimal PV movement inputted into the controller.

FIG. 9A is a simplified pictorial illustration of a side view of the suspension apparatus of FIG. 2A in a “Home position” 900, in accordance with an embodiment of the present invention;

FIGS. 9A-9D schematically describe some of the different “working modes” in which system 100 may be.

FIG. 9A schematically describes a “Home position” 900. In the “Home Position”, the position of the solar panels 210 is above the trees 130. The position of the panels is defined as the distance between a center of the tree 131 and a center of the panel 211 as shown in the drawing.

In the “Home Position”, the system gives some protection to the trees (shielding), the temperature under the solar panels is slightly higher, the panels provide the trees with some protection from winds and the panels 210 provide protection to the trees from frost, hail, snow and rain.

The systems is constructed and configured to enter “Home Position” in the following situations:
a) Overnight parking (from sunset until sunrise the next day); and
b) Windstorms, frost, rain, hail and snow and other weather dangers to the crop.

FIG. 9B is a simplified pictorial illustration of a side view of the suspension apparatus of FIG. 2A in a “Sun position” 920, in accordance with an embodiment of the present invention;

FIG. 9B schematically describes a solar position 920—“Sun Position”. In this state, the sun's radiation reaches the trees and the shade of the panels 302 falls on the passages/empty rows 165. This mode is a dynamic mode which is dynamically changing with the location of the sun (altitude 682 and Azimuth 692). The location of the solar panels changes continuously or at pre-set time intervals (e.g. every 5 minutes). This state is basically the default state of the system during daylight hours, when there are no extreme states of radiation or of weather. The dynamic position of the panels defined in the image as a Y-Control 902 and is a distance between the center of a reference panel (or cart) (usually the first panel) 211 and center 131 of adjacent tree. The Y-Control value is maintained for all trees and all panels, because the distance between the panels is the same as the distance between the trees.

The system enters the “Sun Position” under the following circumstances:
a) sun hours.

The system is further constructed and configured to exit the “Sun Position” to switch to other defined modes, under extreme weather conditions such as, but not limited to:
a. Transition/excess heat loads and temperatures, detected in/by the sensors;
b. When the temperature is below the set temperature in the system;
c. Windstorms, frost, rain, hail and snow or other changes of weather;
d. When solar radiation exceeds the level of critical radiation appropriate to the type of crop/tree growth in question.

FIG. 9C is a simplified pictorial illustration of a side view of the suspension apparatus of FIG. 2A in a “Shade position” 940, in accordance with an embodiment of the present invention.

FIG. 9C schematically describes the shade mode 940—“Shade Position” This mode is the opposite of solar mode 920. In shade mode, a shade 904 from the solar panels and cart 210 falls on the trees 130 and the direct sunlight hits the service aisles 165. This mode is also dynamic and is continuously calculated by the controller 420.

The system enters a Shade Position, inter alia, under the following circumstances:
a. Extreme heat condition in which the ambient temperature exceeds the set temperature value in the system; and
b. When the level of solar radiation exceeds the level of critical radiation appropriate to the type of growth/crop in question.

FIG. 9D is a simplified pictorial illustration of a side view of the suspension apparatus of FIG. 2A in a maintenance position 960, in accordance with an embodiment of the present invention.

“Manual Position Mode”—in this mode, one may control the position of the panels and control their travel speed and direction. This mode is mainly designed for system maintenance modes where the maintenance person can have complete control over the movement of the panels. A maintenance vehicle 962 may be introduced to the aisle 165.

Reference is now made to FIG. 10, which is a simplified flowchart of a method 1000 for optimizing photosynthetic crop production and photovoltaic energy generation outdoors, in accordance with an embodiment of the present invention.

The flow chart depicts some possible states described above and the logical conditions for transition from state-to-state (mode-to-mode or position-to-position).

Some examples are home position 900, solar position 920, shade mode 940 maintenance position mode 960, shown in FIGS. 9A to 9D, respectively.

In a starting step 1002, the system is switched on and all the elements thereof, depicted in FIG. 1, FIG. 4 and FIG. 5 are activated.

System 400 is constructed and configured to be controlled by controller 420, using Agrivoltaic model 560 (with inputs from agrivoltaic model 550, sun location model 540 and photosynthesis model 530, as depicted in FIG. 5).

In a checking time step 1004, the system is checking sun model to find sunrise and sunset time to define daytime. If the current time is not defined as daytime, then the system moves to home position home position 900 (FIG. 9A), in a night time setting step 1006.

If it is daytime then, the system performs an ambient temperature check to see if the ambient temperature is above the high limit specified (e.g. 40 degrees Celsius or more), in a high temperature checking step 1008.

If yes, then the system is operative to move the panels to a shade position (shade mode 940—“Shade Position”) in a protecting crop from overheating step 1010.

If no, then the system tests if the temperature checked in step 1008 is less than specified low limit (e.g. zero degrees Celsius), in a low temperature checking step 1012.

If yes, then the system is operative to move the panels to a “Home position” in a in a protecting crop from low temperature step 1014.

If no, then the system checks to see if the crop/trees have received more solar radiation from the sun than its/their critical radiation level per FIG. 6A, in an irradiance checking step 1016.

If yes, then the system is operative to move the panels to a shade position, in a protecting crop from over-irradiation step 1018.

If no, then the system is operative to check for snow/hale/storm/other in a weather checking step 1020.

If yes, then in a protecting crop from bad weather step 1022, the system moves the panels to their home position.

If no, then the system is operative to move the panels to a sun position (a solar position 920—“Sun Position”, FIG. 9B).

The system is operative to repeat flowchart 1000 continuously or every few minutes or any other time interval pre-defined by system 400.

At night the default mode is “Home Position” and during the sun the default mode is “Sun Position” when the system continuously checks the conditions that require changing mode.

FIG. 11 is a simplified table of decision making parameters 1100 for solar panel position in the method of FIG. 10, in accordance with an embodiment of the present invention.

The table shows the different suitable modes/positions 1104 of the panels 110/carts 210, that have been defined for each type of event 1102, for which they are suitable and what is an example of a trigger 1106 for the transition between the modes.

FIG. 12 is a simplified pictorial illustration showing a side view of a suspension apparatus 1200 with a solar panel 1220 configured to rotate about an axis 1226 to a rotated position 1224, in accordance with an embodiment of the present invention. This figure schematically depicts a combination of a horizontal solar tracking system (such as system 400, FIG. 4) for “Shade management” with horizontal motion as described in the specification and previous figures, along with a single-axis rotational solar tracking apparatus 1200 for increasing power outputs by rotating the panels about their axes, perpendicular to the sun rays 152.

Apparatus 1200, is, for example, based on integration of horizontal moving tracker for shade control 180 with a single-axis rotary solar tracker 1222, 1226 for optimizing electrical generation, The horizontal tracker optimize the agriculture crop and the rotary tracker optimize the electricity generation.

In the integrated controller system, at least two motors (not shown) may be operated for each row of panels, one for horizontal movement of the entire row of panels for shadow management and the other for single-axis rotation of the panels in perpendicular to the sun rays to increase power outputs.

FIG. 13 is a simplified pictorial illustration showing a side view of a sun-tracking suspension apparatus 1300 with solar PV panel 110 rotation about an axis 1226, in accordance with an embodiment of the present invention. A PV cart 1310 comprises a second set of pulleys/cables 1304 and cogwheels 1306, in mechanical connection with a second motor (1308, not shown). The second motor is configured to rotate the panels above axes 1226 to track the sun. The PV carts are constructed and configured to move the panels horizontally along a first set of rails/cables 1324, disposed in a horizontal direction to provide controlled shade for the crops/trees.

The references cited herein teach many principles that are applicable to the present invention. Therefore, the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended embodiments.

1-42. (canceled)

43. An agri-voltaic system for improved solar incidence control on a photosynthetic crop according to a type of a photosynthetic crop, installed above the photosynthetic crop, the system comprising:
a) at least one solar energy apparatus comprising at least one row of solar panels, deployed to receive solar radiation from the sun; and
b) a processor configured to activate an algorithm for dynamic control of horizontal movement of said at least one row of solar panels to form a position of incidence of shading in rows of shade on at least one rows of crop and/or at least one service passage on ground parallel to at least one rows of crops in accordance to a requirement of solar radiation of said at least one rows of crop, said system configured to control said solar incidence on said photosynthetic crop in accordance with said type of photosynthetic crop.

44. An agri-voltaic system according to claim 43, wherein shading from said at least one row of solar panels falls at least partially on said at least one service passage on said ground parallel to said at least one row of photosynthetic crop, wherein said at least one row of photosynthetic crop comprises at least one row of trees, responsive to a solar energy requirement of said at least one rows of photosynthetic crop.

45. An agri-voltaic system according to claim 44, wherein said photosynthetic crop is selected from trees and vines and the system is deployed in an orchard or a vineyard.

46. An agri-voltaic system according to claim 45, wherein a distance between two rows of panels is equal to a distance between two rows of trees.

47. An agri-voltaic system according to claim 45, further comprising a suspension apparatus for suspending said at least one row of solar panels at a height above and parallel to said rows of trees, the suspension apparatus comprising:
i. at least one vertical support element for supporting said at least one row of solar panels at said height; and
ii. at least one movable element for horizontally moving said at least one row of solar panels at said height,
wherein each of said at least one service passages has a width equal or greater to a width of each of said at least one row of trees.

48. An agri-voltaic system according to claim 43, further comprising at least one of:
a. A DC: AC current inverter;
b. radiation and micro-climate sensors;
c. at least one horizontally movable panel support; and
d. at least one panel tilt angle moving element configured to tilt said at least one row of solar panels according to instructions received from said processor.

49. An agri-voltaic system according to claim 48, wherein said instructions are determined by said algorithm, and wherein said algorithm uses at least one input parameter selected from the group consisting of
a. plantation/orchard dimensions;
b. geographical coordinates of the;
c. an altitude above sea level of the orchard;
d. a type of growth/crop and its critical level of radiation;
e. a distance between the trees (Dt);
f. a height of the trees (Ht);
g. a width of the foliage footprint of the trees (Wt);
h. an azimuth of the rows of trees;
i. a width of the panel;
j. a width of a row of panels;
k. a momentary position of the sun, selected from azimuth and elevation; and
l. a height of the panels from the ground (Hp).

50. An agri-voltaic system according to claim 49, wherein:
a. said at least one row of solar panels comprises a plurality of rows of solar panels, and wherein said plurality of rows of solar panels is deployed at a distance from and height above said rows of trees;
b. said distance and said height is determined by growth parameters of said trees;
c. said at least one moveable element comprises at least one wheel in mechanical connection with said at least one horizontally movable panel support;
d. said algorithm is further configured to dynamically control an area of incidence of shading from said at least one row of solar panels;
e. a distance from a center of two adjacent rows of panels is equal to a distance between two adjacent rows of trees;
f. further comprising a set of rails for supporting said at least one wheel;
g. further comprising a set of pulleys for supporting said at least one wheel; and/or
h. said at least one row of solar panels is configured for horizontal movement in a direction perpendicular to trees in said at least one rows of trees.

51. An agri-voltaic system according to claim 50, wherein said horizontal movement is back and forth in a direction perpendicular to trees in said at least one rows of trees and to said service passages.

52. A method for improved solar incidence control on a photosynthetic crop, from an agri-voltaic system, installed above an orchard or vineyard, the method comprising:
a) deploying at least one solar energy-driven apparatus comprising at least one row of solar panels at a height above and at a distance from at least one row of photosynthetic crop; and
b) activating an algorithm to dynamically control a position of incidence of shading in rows of shade from said at least one row of solar panels onto at least one of at least one row of crop and at least one service passage on ground parallel to at least one row of crop thereby optimizing solar incidence on said crop in accordance with a specific requirement for solar radiation on said specific type of crop.

53. A method according to claim 52, wherein said shading from said at least one row of solar panels falls at least partially on said at least one parallel service passage on said ground parallel to said at least one row of crop.

54. A method according to claim 53, further comprising at least one of:
a. dynamically controlling a micro-climate in a vicinity of said photosynthetic crop over time;
b. inverting said energy from at least one photovoltaic cell in said at least one solar energy-driven apparatus from DC to AC;
c. tilting at least one solar panel to increase absorbance of solar radiation; and
d. tilting at least one solar panel to induce said shading.

55. A method according to claim 54, wherein said tilting is in accordance with instructions determined by an algorithm, and wherein said algorithm uses at least one input parameter selected from the group consisting of
a. plantation/orchard dimensions;
b. geographical coordinates of the orchard (data for initializing the solar model);
c. an altitude above sea level of the orchard;
d. a type of growth/crop and its critical level of radiation;
e. a distance between the trees (Dt);
f. a height of the trees (Ht);
g. a width of the foliage footprint of the trees (Wt);
h. an azimuth of the rows of trees;
i. a width of the panel;
j. a width of a row of panels;
k. a momentary position of the sun, selected from azimuth and elevation; and
l. a height of the panels from the ground (Hp, 662).

56. A method according to claim 55, wherein at least one of the following occurs:
a. said at least one row of solar panels comprises a plurality of rows of solar panels;
b. said area of incidence of shading falls on ground in between rows of said crop; and
c. said at least one row of trees comprises a plurality of rows of trees and wherein said a plurality of rows of trees are inter-disposed with said plurality of rows of solar panels.

57. A method for optimizing utilization of solar radiation at an outdoor location in an orchard, the method comprising:
a) deploying at least one solar energy apparatus comprising a plurality of rows of solar panels at the outdoor location to absorb solar radiation, wherein said rows of solar panels are deployed in parallel to rows of trees in said orchard and said rows of trees are inter-dispersed with rows of service passages;
b) generating electrical energy from said plurality of rows of solar panels in electrical connection with at least one photovoltaic cell;
c) partially shading said rows of trees with said plurality of rows of solar panels if said solar radiation level is equal to or above said first threshold and below a second threshold; and optionally
d) fully shading said rows of trees with said plurality of rows of solar panels, if said solar radiation level greater than said second threshold, wherein each of said service passages has a width equal or greater to a width of each of said rows of trees.

58. A method according to claim 57, wherein said plurality of rows of solar panels move to protect said rows of trees from hail, rain, snow, wind, heat, dust, cold or frost.

59. An agri-voltaic system according to claim 43, wherein the solar energy apparatus is deployed on at least one of:
i. at least one cable;
ii. at least one rail; and
iii. at least one mechanical moveable support,
whereby the apparatus is operative to control full or partial shading of the photosynthetic crop and wherein said at least one cable or said at least one rail enables said at least one row of solar panels to slide horizontally above said photosynthetic crop.
